(19) United States
(12) Patent Application Publication
(10) Pub. No.: US 2006/0097922 A1
(43) Pub. Date: May 11, 2006

(54) Method and system for a single-fed patch antenna having improved axial ratio performance

(75) Inventor: Mohamed S. Mahmoud, Sunnyvale, CA (US)

Correspondence Address: STERNE, KESSLER, GOLDSTEIN & FOX P.L.L.C., 1100 NEW YORK AVE., N.W., WASHINGTON, DC, 20005, US

(73) Assignee: The MITRE Corporation

(21) Appl. No.: 10/983,603

(22) Filed: Nov. 9, 2004

(51) Int. Cl. H01Q 1/38

(52) U.S. Cl. 343/700 MS; 343/705

(57) ABSTRACT

A micro-strip antenna includes a conducting ground plane and a dielectric substrate mounted above the conducting ground plane. A patch element is mounted above the dielectric substrate and configured to produce an antenna pattern. The antenna pattern is formed by a number of linear polarization components. The patch element includes a single feed point extending through the conducting ground plane and the dielectric substrate. Two or more notches within the patch element are configured to perturb each of the linear polarization components.

### STATEMENT REGARDING FEDERALLY-SPONSORED RESEARCH AND DEVELOPMENT

Part of the work performed during development of this invention utilized U.S. Government funds. The U.S. Government has certain rights in this invention.

### BACKGROUND OF THE INVENTION

1. Field of the Invention

The present invention relates generally to the field of patch antennas.

More specifically, the present invention relates to deriving dual-band performance characteristics from a micro-strip patch antenna.

2. Background Art

A transformation to information driven network centric warfare has been receiving much attention of late. Connectivity between systems and platforms is required to achieve the goals of this transformation. The air and ground communications networks supporting this connectivity require survivable and secure free space optical and radio frequency (RF) links.

A component critical to network operations and connectivity, is the physical layer. The current physical layer supporting conventional communications networks, however, is not adequate or affordable for airborne platforms used in military communications. Physical layers of lower cost and improved capabilities need to emerge. Multi-beam phased array antennas have the potential to improve physical layer capabilities through the realization of multiple and simultaneous electronically adaptable beams.

Cost factors have previously made this multi-beam technology largely unaffordable. However, with new emerging technologies in phased array antennas, there is a tremendous potential to lower the cost. Additionally, through the development of generic solutions that can apply to a multitude of platforms, production volumes can be increased to further reduce the costs.

Micro-strip patch antenna radiators are well suited for use in multi-beam phased array antennas and have lower manufacturing costs than other approaches. Micro-strip antenna patches have been widely used in phased array applications due to their low profile and conformal shape. Micro-strip patch antennas are easy to package and include multilayer circuit components for a highly manufacturable antenna system for communication applications.

Micro-strip patch antennas also can be designed to meet bandwidth, efficiency, and power handling requirements for communication applications. Additionally, arraying micro-strip patches in large numbers is considerably easier and less expensive than many other types of array antennas. These features make micro-strip patch antenna radiators especially desirable for use in air (e.g., satellite-based) and ground communications networks.

By way of background, the interplay of key technical parameters influence the economies of using micro-strip patch antennas in satellite-based communication networks. First, antennas used in satellite-based communications are typically circularly polarized. Circular polarization (CP) is preferred in satellite communications because CP generally provides better performance characteristics than other types of polarization. For example, CP antennas can more easily compensate for the satellite's movement with respect to the earth and compensate for other anomalies, such as Faraday rotation.

Another key performance parameter, axial ratio, can be viewed as a measure of circular polarization purity (roundness).One challenge with using conventional micro-strip patch antennas in satellite communications is achieving acceptable axial ratio values over the required bandwidth. Axial ratio can be more easily controlled through antenna configurations where multiple feed points (within the patch) are used to energize the micro-strip patch antenna. For example, circular polarization typically requires two or four feed points to excite patch antenna elements with a high level of polarization purity. These multiple feed arrangements, however, translate into additional power consumption and costs.

Thus, although multiple feed point patches are traditionally used for better CP, a single feed point patch would be preferred, for example, to lower power consumption necessitated by the hybrid feed dividers/circuitry. Using a single feed point would eliminate power dividers that can introduce undesired losses, especially over wider bands within preferred operating frequency ranges. In the case of a single feed point, however, additional polarization impurities can be introduced. These polarization impurities must be counter-balanced if acceptable antenna performance is to be maintained. There are several well known conventional approaches for counter-balancing the effects of single-fed antennas. Some of these conventional approaches include diagonally-fed nearly square patch antennas, truncated corner square patch antennas, and a square patch antenna with a diagonal slot. These conventional approaches provide acceptable CP with small axial ratio values and good voltage standing wave ratio (VSWR). Unfortunately, these conventional configurations perform well only across very narrow bands . This narrow bandwidth performance limits use of these traditional techniques within the broadband and high speed data environments characteristic of robust air and ground communication networks of today and in the future.

What is needed, therefore, is a patch antenna having the single feed point and acceptable axial ratio performance (e.g., below 2 dB over the main beam peak) over a specified frequency range of approximately 5-10%. More specifically, what is needed is a circularly polarized patch antenna element having with a desirable VSWR capability of less than 2:1 over the specified frequency range.

### BRIEF SUMMARY OF THE INVENTION

Consistent with the principles of the present invention as embodied and broadly described herein, a micro-strip antenna includes a conducting ground plane and a dielectric substrate mounted above the conducting ground plane. Also included is a patch element mounted above the dielectric substrate and configured to produce an antenna pattern. The antenna pattern is formed by a number of linear polarization components. The patch element includes a single feed point extending through the conducting ground plane and the dielectric substrate. Two or more notches within the patch element are configured to perturb each of the linear polarization components.

Further embodiments, features, and advantages of the present invention, as well as the structure and operation of the various embodiments of the present invention are described in detail below with reference to the accompanying drawings.

### BRIEF DESCRIPTION OF THE DRAWINGS

The accompanying drawings, which are incorporated in and constitute part of the specification illustrate embodiments of the invention and, together with the general description given above and the detailed description of the embodiments given below, serve to explain the principles of the present invention. In the drawings:

FIG. 1 is a high level illustration of an exemplary platform on which the present invention can be implemented;

FIG. 2 is a high level illustration of a phased antenna element array that can be used in the implementation of FIG. 1;

FIG. 3 is an illustration of a conventional patch antenna;

FIG. 4 is an illustration of an exemplary patch antenna constructed in accordance with an embodiment of the present invention;

FIG. 5 is a more detailed illustration of the exemplary patch antenna shown in FIG. 4;

FIG. 6 is a graphical illustration of axial ratio;

FIG. 7 is an illustration of current flow associated operation of a single-fed patch antenna with and without slots;

FIG. 8 is an illustration of the interaction of circularly polarized currents to produce a linearly polarized radiation vector;

FIG. 9 is a transmission line ring model for slotted circular patch antenna in accordance with the embodiment shown in FIG. 5; and

FIG. 10 is an exemplary method of practicing an embodiment of the present invention.

### DETAILED DESCRIPTION OF THE INVENTION

The following detailed description of the present invention refers to the accompanying drawings that illustrate exemplary embodiments consistent with this invention. Other embodiments are possible, and modifications may be made to the embodiments within the spirit and scope of the invention. Therefore, the detailed description is not meant to limit the invention. Rather, the scope of the invention is defined by the appended claims.

The present invention, as described below, may be implemented in many different embodiments of software, hardware, firmware, and/or the entities illustrated in the figures. Any actual software code with the specialized control of hardware to implement the present invention is not limiting of the present invention. Thus, the operational behavior of the present invention will be described with the understanding that modifications and variations of the embodiments are possible, given the level of detail presented herein.

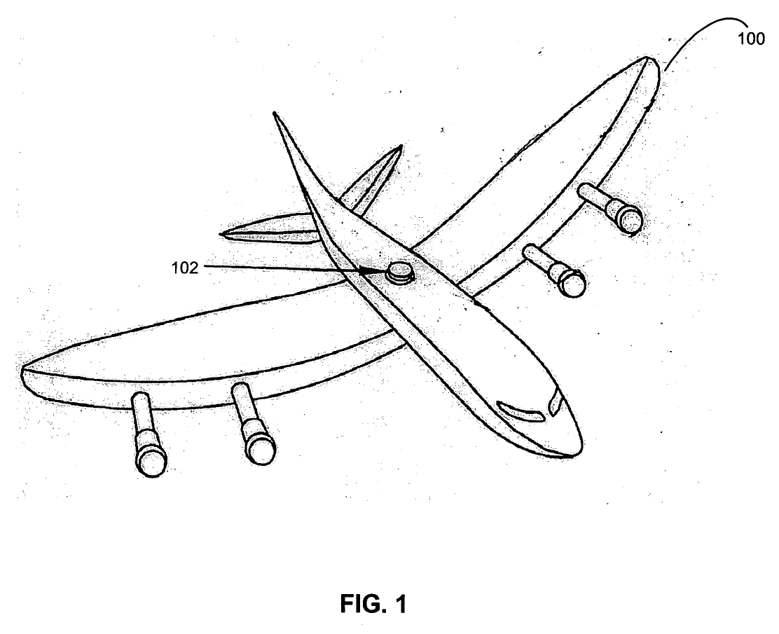

FIG. 1 is an illustration of an exemplary platform, such as an aircraft 100, upon which an embodiment of the present invention can be implemented. In FIG. 1, the aircraft 100 can represent a node of an information driven communications network. The aircraft 100 includes, for example, a phased array antenna 102 configured for directing multiple beams at different targets simultaneously. The aircraft 100 and the antenna 102 can be used for communication with satellite based communications network.

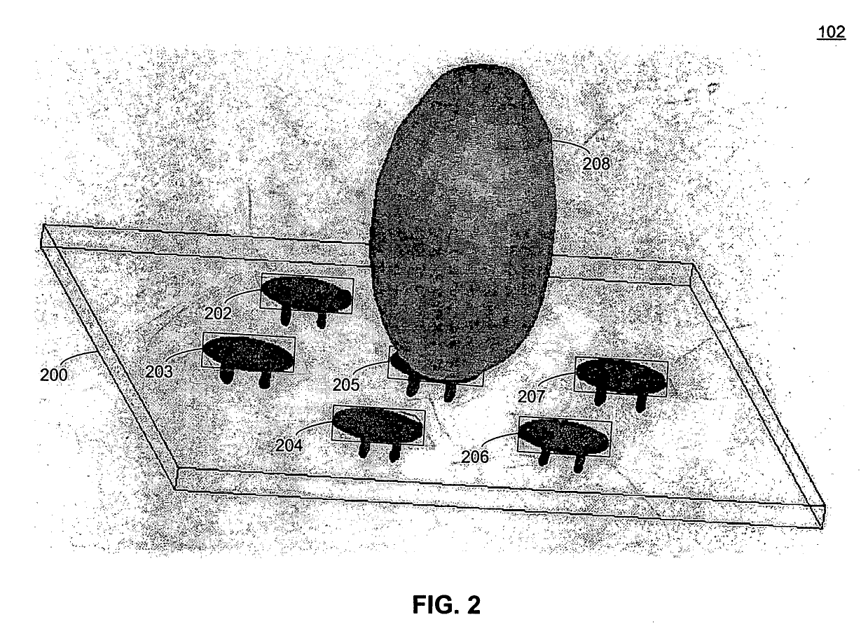

FIG. 2 is a high level illustration of the phased array antenna 102 shown in FIG. 1. In FIG. 2, the phased array antenna 102 includes one or more individual antenna arrays, such as an antenna array 200. The antenna array 200 includes conventional micro-strip patch antenna elements 202-207. Each of the conventional patch antenna elements 202-207 radiates a circularly polarized antenna pattern, such as antenna pattern 208.

In the antenna array 200, each of the micro-strip elements 202-207 can be used as a element within the multi-element array 200. Alternatively, each of the elements 202-207 can be used as a separate, independently radiating antenna. Antenna beams produced by the array 200 can be steered by shifting their phase. For example, in the antenna array 200, beams constructively and/or destructively interfere with one another so as to steer a relatively broad combined beam, or individual beams, in a desired direction.

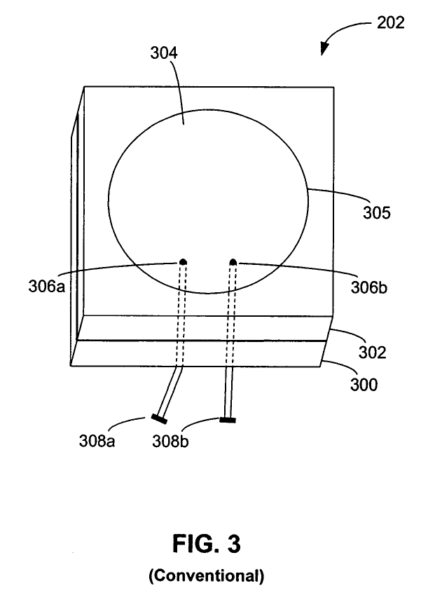

FIG. 3 is a detailed illustration of a conventional micro-strip patch antenna that can be used to implement a micro-strip element such as element 202, shown in FIG. 2. In FIG. 3, the micro-strip patch element 202 includes a thin conducting ground plane 300. The conducting ground plane 300 includes either a metallic or a resistivity-tapered surface and assists in the suppression of antenna pattern back-lobes. A dielectric material substrate 302 is positioned on, or near, a surface of the conducting ground plane 300. The dielectric substrate 302, typically a few hundred mils thick (a “mil” is 0.001 inches), has a low dielectric constant and is used to reduce fringing electromagnetic (EM) fields.

Next, a micro-strip patch 304 is positioned on, or near, a surface of the dielectric substrate 302. The micro-strip patch 304 consists of a radiating patch of any planar geometry (e.g., annular, square, elliptical, and rectangle) and can be constructed of any suitable conductive material, such as copper or aluminum. Micro-strip patches, generally, can have a thickness from about 1 to 2 mils. In FIG. 3, the micro-strip patch 304 is annular, although any suitable geometry can be used.

As known in the art, an important characteristic of micro-strip antennas, such as the array element 202, is their inherent ability to radiate efficiently despite having a low profile. The primary source of this radiation is the EM fringing fields produced along a periphery 305 of the micro-strip patch 304.

The micro-strip patch 304 includes feed points 306a and 306b. The feed point 306a provides an insertion point for attachment of a coaxial probe 308a to the patch 304. Similarly, the feed point 306b facilitates attachment of a coaxial probe 308b. The feed points 306a and 306b (and respective probes 308a and 308b) are symmetrically positioned within the patch 304 such that excitation amplitudes and phase angles, desired to achieve particular patterns of polarizations, can occur.

The coaxial probes 308a and 308b extend up through the conducting ground plane 300 and the dielectric substrate layer 302 to feed energy to the micro-strip patch 304. Each of the probes 308a and 308b is connected, on one end, to one of the feeds points 306a and 306b, respectively. The other ends of the coaxial probes 308a and 308b are connected to a transmission line. The transmission line, in turn, is connected to a communications device, such as a radio.

The multi-feed arrangement (i.e., feeds 306a and 306b) shown in FIG. 3 provides good control of axial ratio. As noted above, CP typically requires two or four feeds, as shown in FIG. 3, to excite the patch element 304 with a high level of polarization purity. Each feed point requires a corresponding power divider. As the number of power dividers increases, especially in complex feed networks, so does the introduction of undesirable losses. Therefore, in advanced transmit phased array arrangements, a single feed point design is preferred over multiple feed points to minimize these undesirable losses.

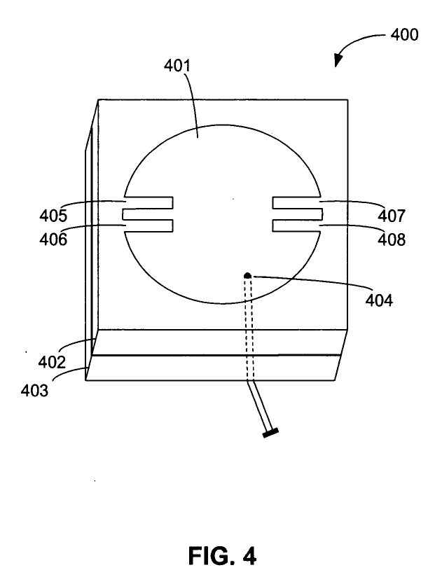

FIG. 4 is an illustration of a patch antenna element 400 constructed in accordance with an embodiment of the present invention. In FIG. 4, the patch antenna element 400 includes a micro-strip patch 401 positioned above a dielectric substrate 402 and a conducting ground plane 403. The micro-strip patch 401 includes only a single feed point 404. The single feed approach of the antenna element 400 minimizes RF losses and improves gain where the gain is referenced at the coaxial input port 308 shown in FIG. 3. The single feed also simplifies hardware manufacturing, and reduces overall costs.

The motivation to use multiple feed points in a patch design is to provide a high quality circularly polarized signal that a single feed point was conventionally not able to provide. The present invention, however, uses the single feed point approach but still manages to maintain quality circular polarization and good axial ratio performance.

To obtain good axial ratio performance with the single-feed point 404, the antenna element 400 uses multiple (two or more) slots, or notches, on each side of the micro-strip patch 401. The use of multiple slots minimizes undesirable linear polarization components and reinforces the circular polarization currents in one direction.

In the micro-strip patch 401, for example, two slots (405 and 406) are formed on one side and two slots (407 and 408) are formed on the other side. Although other geometries can be used, the micro-strip patch 401 has a substantially annular geometry and includes the four substantially identical slots 405-408.

The micro-strip patch 401 lies on the thin dielectric substrate layer 402 of low permittivity above the ground plane 403. The micro-strip patch 401 has a low profile (e.g., small size), which makes it suitable for conformal and mobile applications. Additionally, the micro-strip patch 401 is constructed in a manner that provides adequate bandwidth, about 7%, which is desirable in high capacity broadband satellite communication systems.

A circularly polarized signal is composed of two linearly polarized (LP) signals. These LP signals are equal in magnitude and orthogonal in both space and time. A deviation in magnitude equality, and/or orthogonality in space or time, results in an impurity to the CP signal. That is, the CP signal becomes elliptical instead of being purely circular. Axial ratio quantifies this ellipticity.

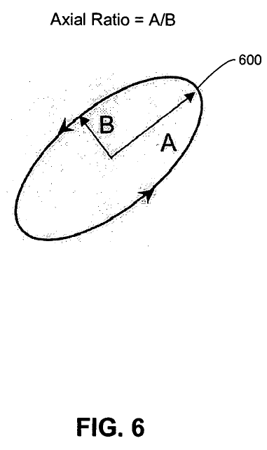

FIG. 6 is a graphical illustration 600 of axial ratio. More particularly, the illustration 600 indicates quantification of the CP impurity. This CP impurity is typically expressed as axial ratio (AR) or cross polarization (XPOL). Perfect CP, for example, corresponds to unity AR (0 dB). In the illustration 600, AR is expressed as a function of a magnitude A divided by a magnitude B (where the vectors A and B are perpendicular).

Circular polarization is most often preferred in satellite communications. This is particularly desirable since the polarization of a linear polarized radio wave may be rotated (e.g., Faraday rotation) as the signal passes through anomalies in the earth's ionosphere. Furthermore, due to the position of the earth with respect to the satellite, geometric differences may vary especially if the satellite appears to move with respect to the fixed earthbound station. CP will keep the signal constant regardless of these anomalies.

A circular patch generates, for example, left hand CP using a single feed point. In the case of the single feed point, asymmetrical linearly polarized components are formed. Consequently, two orthogonal modes (i.e., signals) must be generated by perturbing the geometry of the patch to form reasonably pure CP components. These geometric perturbations are represented by introduction of the slots. Each of the slots forms its own CP components, which act as a counter-balance to the asymmetrical linearly polarized components.

More specifically, a conventional annular micro-strip patch generates left hand circular polarization when it uses only a single feed. Forming slots introduces perturbations to the currents to help reinforce this left hand circular polarity. The inventor has discovered that using more than one slot on each side of the patch will further reinforce the circular polarization current distribution. This reinforced current distribution helps to maintain the quality of circular polarization across the required frequency band. Reinforcing the current distribution also helps improve the axial ratio over greater bandwidths.

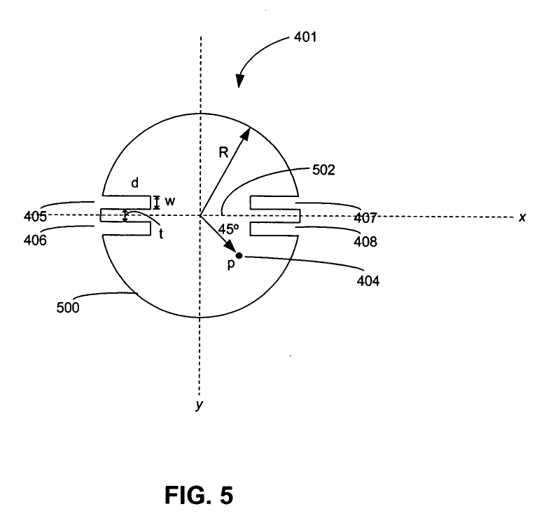

FIG. 5 provides a more detailed illustration of the micro-strip patch element 401 shown in FIG. 4. In FIG. 5, the micro-strip patch 401 is shown in a manner that more clearly conveys specific geometric features associated with the slots 405-408. The slots 405-408 are formed substantially symmetrically along x and y axes, as indicated. Although various numbers of slots can be used, the exemplary patch 401 uses the four substantially identical slots 405-408. The feed point 404 is located in a fourth quadrant at −45° from a point of origin. The geometry of the parameters associated with the slots 405-408 are represented in the following list:
R=radius of the circular patch
w=slot width
d=slot length
t=spacing between slots
p=feed point location from the origin on the 45° radial line.

The inventor of the present application has performed parametric studies to determine optimal values for each of the above geometry parameters (R, w, d, t, p) based upon a set of requirements. Design objectives included frequency of operation from 13.875-14.875 GHz with less than 2:1 axial ratio. The parametric studies, using known techniques, were accomplished by allowing individual parameters to change while the other parameters were kept constant. Return loss, radiation patterns, G/T data, and actual ratio performance have been obtained across different parameter values.

Beginning with the separation between the slots (t), the inventor discovered that the center frequency slightly increases as the separation (t) gets smaller. At 14.375 GHz for example, the return loss slightly improves with smaller separation (t). However, a significantly small separation (t) can be difficult to accurately machine. An exemplary separation value (t) of about 10 mils spacing gives better than 20 dB return loss (approximately 23 dB).

Micro-strip patch antennas, such as the micro-strip patch 401, are resonant elements. Thus, the center frequency of patch antenna elements depends significantly on the radius (R) of the patch. Decreasing the radius (R) from, for example, 160 to 125 mils allows the center frequency to increase from 13.5 to 16 GHz. In general, smaller patches work better at higher frequencies.

The return loss versus the radius (R), at a center frequency of interest (e.g., 14.375 GHz), will indicate that a radius (R) of about 139 mils will optimize the return loss performance. An acceptable return loss is below 10 dB across the bandwidth or 2:1 VSWR. Other performance parameters are factored in as well, such as the axial ratio. For a return loss below 10 dB, the radius (R) can take any value from 120 mils to 147 mils. A determination of the patch's radius (R) will depend on the polarization quality of the radiation pattern as will be discussed below. Exemplary values for (w) and (d), within these ranges of (R), can be from about 1-20 mils and about 50-90 mils, respectively.

Measurement data indicates that a better axial ratio can be obtained with smaller radius (R) values. For example, when (R) equals 124 mils, the axial ratio equates to 0.8 dB (less than 1 dB). Thus, an exemplary radius (R) of 124 mils satisfies the VSWR 2:1 requirement as well, with less than 10 dB return loss across the band.

The location (P) of the feed point 404 is another important feature that effects both the return loss and the axial ratio performance. Generally, the further the feed location (P) from the center of the patch, the higher the resonant frequency. The best location (P) for return loss performance is about halfway between the center location of the patch 401 and its periphery 500. The location (P) controls the location of the nulls and peaks of the fields inside the dielectric cavity (not shown) of the micro-strip patch 401. For example, for the design goals described, the return loss is best when the feed point 404 location (P) is about 73 mils (approximately R divided by two) at 14.375 GHz.

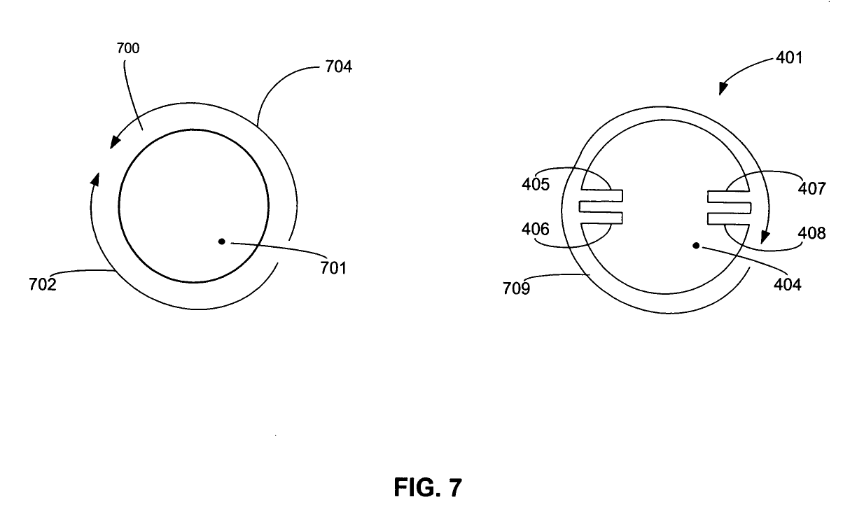

the theory of operation of the slotted circular patch can be explained as two dual modes, or signals, being excited at two different frequencies. The center frequency lies between these two frequencies. At this center frequency, two linearly polarized signals, equal in magnitude and orthogonal in space and time, are combined to create the circularly polarized signal. To illustrate the effect of slots on the exemplary annular micro-strip patch 401, transmission line modeling is provided in FIGS. 7, 8, and 9.

With reference to FIGS. 5 and 7, the periphery 500 of the patch 401 is the effective radiating portion of the antenna. A circular magnetic current typically represents the equivalent current forming the antenna pattern. For example, given a generic circular patch model 700 having a single feed 701 without slots, a linearly polarized signal is produced from two semi-circular magnetic currents 702 and 704 flowing in opposite directions, as shown in FIG. 7. Currents 702 and 704 originate at the single feed location 701, as shown. The two semi-circular magnetic currents 702 and 704 are produced as a result of asymmetrical geometric effects caused by the single feed point 701.

As will be discussed in greater detail below, by adding the slots (notches) 405-408 as shown in FIG. 7, the two semi-circular currents 702 and 704 are transformed into a more purely circular current 709. The slots 405-408 are provided to help maintain circular polarization purity within the patch 401, as noted above.

More specifically, in the patch 401 having the single feed 404, a single linearly polarized signal is produced from the two opposing semi-circular magnetic currents 702 and 704. As discussed above, in the absence of feeds and in the absence of slots, a circular magnetic strip patch antenna will generally produce a purely circularly polarized signal.

When the single feed 404 is formed in the patch 401, for example, a purely circularly polarized signal is transformed into the two semi-circular magnetic currents 702 and 704. Due to the presence of the opposing semi-circular magnetic currents 702 and 704, the circular patch model 700 no longer behaves as a purely circularly polarized antenna. Instead, the two semi-circular magnetic currents 702 and 704 cooperate within the patch model 700 to form a linearly polarized signal.

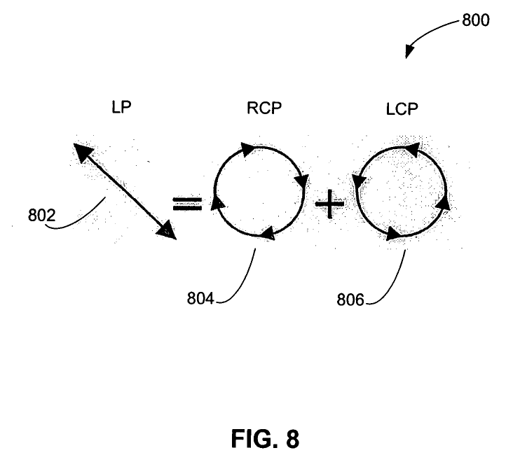

The slots 405-408 introduce a load to the magnetic currents 702 and 704 that counter-balances the linearly polarized signal. The net result of this counter-balancing effect is the restoration of the circular polarization characteristics to the patch 401. More specifically, the slots 405-408 reinforce the current in one direction to generate circular polarization. The EM counter-balancing effect of the slots 405-408 is more clearly shown in the illustration of FIG. 8.

FIG. 8 is an illustration 800 of a linearly polarized signal 802 decomposed into circularly polarized components 804 and 806. The circular components 804 and 806 are equal in magnitude and opposite in direction. For purposes of illustration, the two semi-elliptical magnetic currents 702 and 704 from FIG. 7 might combine to form the linearly polarized signal 802. The linearly polarized signal 802 can then be decomposed into the circularly polarized signals 804 and 806. The circularly polarized signal 804 can have, for example, right hand circular polarization. The circularly polarized signal 806 can have, for example, left hand circular polarization.

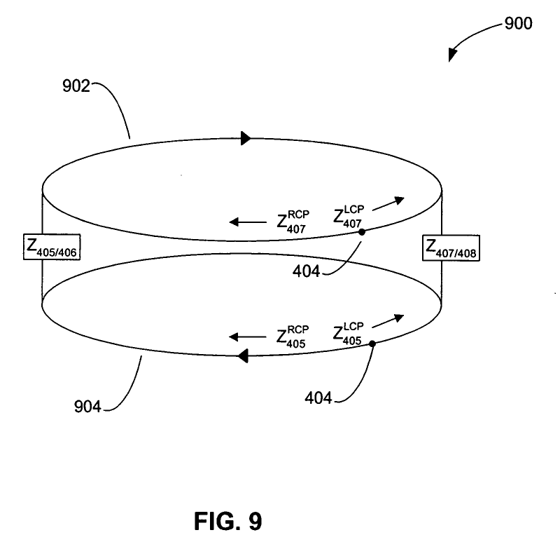

An optimally constructed micro-strip patch, such as the patch 401 (see e.g., FIG. 5), will achieve the best axial ratio by maximizing a magnetic current component in one rotation sense and minimizing a component in another rotation sense to produce a purely circularly polarized signal. This principle is illustrated in FIG. 9.

FIG. 9 is an illustration of a transmission line ring model 900 demonstrating the effect the slots 405-408 have on the circular polarization characteristics of the antenna patch model 700. The idea of the transmission line ring model 900 is that the slots 405-408 help maintain the purity of the circular polarization of the micro-strip patch 401. As mentioned above, circular polarization is produced from two linearly polarized signals that are out of phase with each other. A desirable goal in creating a circularly polarized micro-strip antenna is to maintain the right amplitude and phase relationship between the two linearly polarized signal components to produce a pure circularly polarized signal.

In FIG. 9, for example, the semi-circular magnetic currents 702 and 704, shown in FIG. 7, can be represented as corresponding to transmission lines 902 and 904, respectively. The transmission line 902 can be representative of the semi-circular magnetic current 702 having, for example, right hand circular polarization. Similarly, the transmission line 904 can be representative of the semi-circular magnetic current 704 having left hand circular polarization. The slots 405-408 have the effect of adding shunt impedances Z_{405/406} and Z_{407/408} at opposite sides of the transmission line model 900, as shown in FIG. 9.

Each of the shunt impedances Z_{405/406} and Z_{407/408} corresponds to one of the circumferential magnetic currents 702 and 704 being interrupted by the slots 405-408, at opposite sides. Each of the shunt impedance loads Z_{405/406} and Z_{407/408} can be expressed as input impedances produced at the feed point 404. For the slot 405, for example, its representative input impedance can be divided into one component for right hand circular polarization, such as Z₄₀₅^{RCP} and one for left hand circular polarization Z₄₀₅^{LCP}, as shown in FIG. 9.

Similarly, the slot 407, for example, can be represented at the feed point 404 as a right hand circular component Z₄₀₇^{RCP} and as a left hand circular component Z₄₀₇^{LCP}

Thus, in the exemplary model 900, the components Z₄₀₅^{LCP} and Z₄₀₅^{RCP} counter-balance the circumferential magnetic current 904. The components Z₄₀₇^{RCP} and Z₄₀₇^{LCP} counter-balance the circumferential magnetic current 902.

Referring back to FIG. 7, the magnetic current components are further influenced by the additional slots 406 and 408. That is, the additional slots 406 and 408 enhance the overall counter-balancing effect. In FIG, 7, for example, the two slots 405 and 406 counter-balance one of the magnetic currents 702 and 704. The two slots 407 and 408 counter-balance the other of the currents 702 and 704. This additional enhancement produces the more pure circular polarization current 709, shown in FIG. 7. Although two slots are shown on each side of the patch 401, any suitable number of slots can be used.

Proper construction of micro-strip patches with slots generally involves matching of the right hand circular polarized impedance components. At the same time, a mismatching of all of the left hand circular polarization impedance components occurs. This process of matching and mismatching ultimately causes the net current to flow in one direction and not the other. Consequently, a relatively pure circularly polarized signal is formed. The axial ratio will mainly depend on how much the left hand circular polarization component is mismatched compared to the matched right hand circular polarization component. Dual slots facilitate this matching and mismatching over wider bandwidths than have previously been demonstrated.

The specific geometric features of slots, such as the dual slots 706 (a/b) and 708(a/b), can be determined using known techniques in accordance with specific user requirements. One such exemplary technique is method of moments (MoM) analyses. A MoM analysis is one of the most widely accepted numerical techniques for providing a rigorous electromagnetic solution to micro-strip antennas.

By way of review, the MoM technique is based on solving Maxwell's equations in the integral equation (IE) form to derive the equivalent current distribution on the intended structure. The boundary conditions from conductors, dielectrics, and radiation are all absorbed in Green's function that represents part of the integrand. Since these techniques are widely known, they need not be further discussed herein.

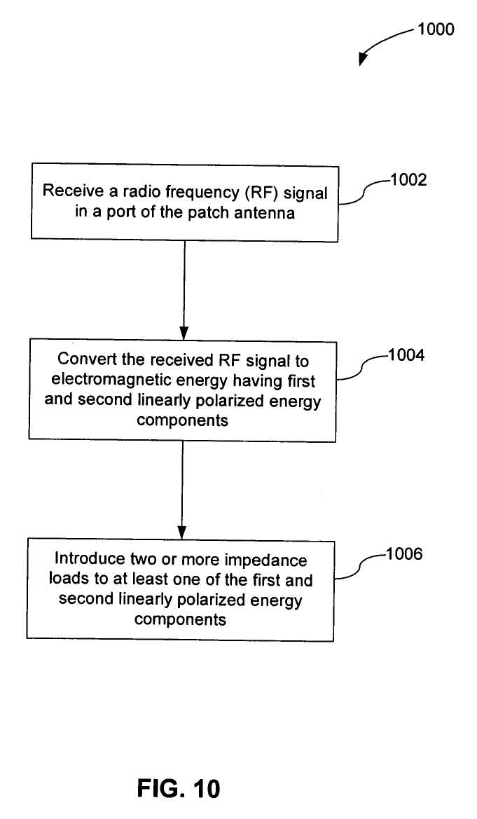

FIG. 10 is an illustration of an exemplary method 1000 of practicing an embodiment of the present invention. In FIG. 10, a radio frequency signal is received in a port of a patch antenna as indicated in step 1002. In step 1004, the received RF signal is converted to an electromagnetic energy having first and second linearly polarized energy components. Two or more impedance loads are introduced to at least one of the first and second linearly polarized energy components, as indicated in step 1006.

### Conclusion

The present invention provides a micro-strip patch antenna element that generates a circularly polarized signal. This patch element can be used as a stand alone antenna radiator or as an element of an antenna array having a larger number of patch elements. The micro-strip patch of the present invention facilitates the use of a single feed point, or probe, rather than of multiple feed points of conventional patch antennas. In this manner, the micro-strip patch of the instant invention reduces the need for additional power dividers.

The single feed approach discussed herein minimizes RF losses, improves efficiency, helps thermal performance, simplifies hardware manufacturing, and reduces the associated costs. These improvements make micro-strip patches more adaptable for use in network environments that require more robust communication links.

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art (including the contents of any references cited herein), readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What we claim is:

1. A patch antenna comprising:
a ground plane;
a conductive patch element having a substantially circular shape, said patch element including at least two notches disposed substantially symmetrically in a circumferential edge of said patch element; and
a dielectric layer disposed between said ground plane and said patch element to form said patch antenna.

2. A micro-strip antenna, comprising:
a conducting ground plane;
a dielectric substrate mounted on the conducting ground plane;
a patch element mounted on the dielectric substrate and configured to produce an antenna pattern formed by a number of linear polarization components; and
at least two notches formed within the patch element and configured to perturb each of the linear polarization components.

3. The micro-strip antenna of claim 2, wherein the patch element includes only a single feed point, extending through the conducting ground plane and the dielectric substrate.

4. The micro-strip antenna of claim 3, wherein the single feed point is formed about half way between a center of the patch element and an outer circumference thereof.

5. The micro-strip antenna of claim 2, wherein the two notches are substantially symmetrical along x and y axes and substantially parallel with one another.

6. The micro-strip antenna of claim 2, wherein the notches are substantially rectangular.

7. The micro-strip antenna of claim 2, wherein the patch element is substantially annular.

8. The micro-strip antenna of claim 2, wherein the patch element has a radius within a range of about 120 to 130 mils; and wherein the notches have a depth within a range of about 70 to 80 mils.

9. The micro-strip antenna of claim 8, wherein the notches are separated from one another by a distance within a range of about 8 to 12 mils.

10. The micro-strip antenna of claim 9, wherein the single feed point is about 45 degrees from a radial line formed by the notches.

11. A method for enhancing polarization purity of a circularly polarized signal radiated from a single fed patch antenna, comprising:
receiving a radio frequency (RF) signal in a port of the patch antenna;
converting the received RF signal to electromagnetic energy having first and second linearly polarized energy components; and
introducing at least two impedance loads to at least one of the first and second linearly polarized energy components.

12. The method of claim 11, wherein each load perturbs a corresponding one of the first and second linearly polarized energy components.

13. The method of claim 12, wherein the first and second linearly polarized energy components respectively represent left hand and right hand circularly polarized components.

14. The method of claim 13, wherein the electromagnetic energy includes an electric current.

15. An apparatus for enhancing polarization purity of a circularly polarized signal radiated from a single fed patch antenna, comprising:
means for receiving a radio, frequency (RF) signal in a port of the patch antenna;
means for converting the received RF signal to electromagnetic energy having first and second linearly polarized energy components; and
means for introducing two or more impedance loads to at least one of the first and second linearly polarized energy components.

16. The patch antenna of claim 1, wherein the conductive patch element includes only a single feed point extending through the conducting ground plane and the dielectric substrate.

17. The patch antenna of claim 16, wherein the single feed point is formed about half way between a center of the patch element and an outer circumference thereof.

18. The patch antenna of claim 1, wherein the two notches are substantially symmetrical along x and y axes and substantially parallel with one another.

19. The patch antenna of claim 1, wherein the notches are substantially rectangular.

20. The patch antenna of claim 1, wherein the patch element is substantially annular.
